(19) United States
(12) Patent Application Publication
(10) Pub. No.: US 2025/0257439 A1
(43) Pub. Date: Aug. 14, 2025

(54) THERMAL BARRIER COATING (TBC) MATERIAL WITH HIGH FRACTURE TOUGHNESS, CALCIA-MAGNESIA-ALUMINO SILICATE (CMAS) CORROSION RESISTANCE, AND ULTRA-HIGH-TEMPERATURE SINTERING RESISTANCE, AND PREPARATION AND USE THEREOF, AND TBC

(71) Applicants: EAST CHINA UNIVERSITY OF SCIENCE AND TECHNOLOGY, Shanghai (CN); JINAN UNIVERSITY, Guangzhou, Guangdong (CN); AECC BEIJING INSTITUTE OF AERONAUTICAL MATERIALS, Beijing (CN)

(72) Inventors: Xiancheng ZHANG, Shanghai (CN); Xiaolong CHEN, Guangzhou (CN); Haoliang TIAN, Beijing (CN); Junmiao SHI, Shanghai (CN); Binhan SUN, Shanghai (CN); Shantung TU, Shanghai (CN)

(73) Assignees: EAST CHINA UNIVERSITY OF SCIENCE AND TECHNOLOGY, Shanghai (CN); JINAN UNIVERSITY, Guangzhou, Guangdong (CN); AECC BEIJING INSTITUTE OF AERONAUTICAL MATERIALS, Beijing (CN)

(21) Appl. No.: 18/832,071

(22) PCT Filed: Apr. 11, 2023
(86) PCT No.: PCT/CN2023/087429

§ 371 Date: Jul. 22, 2024

(30) Foreign Application Priority Data
Nov. 4, 2022 (CN) 202211374463.5

(51) Int. Cl. C23C 4/11; C04B 35/488; C04B 35/626; C04B 35/64; C23C 4/134

(52) U.S. Cl. CPC C23C 4/11; C04B 35/488; C04B 35/6262; C04B 35/62675; C04B 35/64; C04B 2235/3225; C04B 2235/3246; C04B 2235/6567; C04B 2235/661; C23C 4/134

(57) ABSTRACT

A thermal barrier coating (TBC) material with high fracture toughness, calcia-magnesia-alumino silicate (CMAS) corrosion resistance, and ultra-high-temperature sintering resistance, and a preparation and use thereof are provided, belonging to the technical field of high-temperature/ultra-high-temperature TBCs. In the TBC material, ZrO₂ is co-doped with different rare earth oxides and a crystal defect concentration and a lattice distortion degree are controlled by a doping amount of the rare earth oxides, resulting in a fully-stabilized cubic fluorite crystal structure showing no phase change at a room temperature to 1,600° C. Moreover, the material exhibits high toughness, CMAS corrosion resistance, ultra-high-temperature sintering resistance, and long service life.

### CROSS REFERENCE TO RELATED APPLICATION

This application is a national stage application of International Patent Application No. PCT/CN2023/087429, filed on Apr. 11, 2023, which claims priority of the Chinese Patent Application No. CN202211374463.5 filed to the China National Intellectual Property Administration (CNIPA) on Nov. 4, 2022 and entitled “THERMAL BARRIER COATING (TBC) MATERIAL WITH HIGH FRACTURE TOUGHNESS, CALCIA-MAGNESIA-ALUMINO SILICATE (CMAS) CORROSION RESISTANCE, AND ULTRA-HIGH-TEMPERATURE SINTERING RESISTANCE, AND PREPARATION AND USE THEREOF, AND TBC”, both of which are incorporated herein by reference in their entities.

### TECHNICAL FIELD

The present disclosure relates to the technical field of high temperature/ultra-high temperature thermal barrier coatings, and in particular to a thermal barrier coating (TBC) material with high fracture toughness, calcia-magnesia-alumino silicate (CMAS) corrosion resistance, and ultra-high-temperature sintering resistance, and a preparation method and use thereof, and a TBC.

### BACKGROUND

Currently, the turbine inlet temperature of advanced aerospace engines and gas turbines continues to increase, posing more stringent and strong research and development requirements for the use temperature and service life of thermal barrier coatings (TBCs) on the surfaces of high-temperature hot-end components. For a long time, the development of novel materials that can replace traditional yttria-stabilized zirconia (YSZ) has been an only way to achieve long-life service of the TBCs at an operating temperature of 1,300° C. to 1,600° C. Over the past two decades, a large number of novel high-temperature TBC materials have been developed, such as pyrochlore-type rare earth zirconates, fluorite-type rare earth cerates, perovskite-structured rare earth zirconates, magnetoplumbite-structured rare earth hexaaluminates, rare earth tantalates and niobates, as well as other novel materials with higher phase stability are emerging one after another, and the research is also surging on multi-component doping modification of traditional YSZ materials. However, the extremely harsh high-temperature service environment of TBC causes these novel materials to face various thermomechanical performance defects during use, making their thermal cycle life difficult to meet the development needs of next generations of advanced aerospace engines and gas turbines. It is a key bottleneck problem that needs to be solved in the development of high-performance high-temperature/ultra-high-temperature TBCs to make novel high-temperature/ultra-high-temperature TBC materials not only have a thermal expansion coefficient that matches the metal substrate, but also have low thermal conductivity, excellent resistance to ultra-high-temperature sintering, high fracture toughness, and resistance to CMAS (namely CaO—MgO—Al₂O₃—SiO₂, a main chemical composition of sand dust and volcanic ash).

### SUMMARY

An objective of the present disclosure is to provide a thermal barrier coating (TBC) material with high fracture toughness, resistance to calcia-magnesia-alumino silicate (CMAS) corrosion, and ultra-high-temperature sintering capability, and a preparation method and use thereof, and a TBC. The TBC material has an operating temperature of 1,300° C. to 1,600° C., shows no phase change from a room temperature to 1,600° C., and exhibits high toughness, CMAS corrosion resistance, ultra-high-temperature sintering resistance, and long service life.

To achieve the above objective, the present disclosure provides the following technical solutions:

The present disclosure provides a TBC material, where the TBC material has a chemical composition of ZrO₂; xY₂O₃; y(AₙB₁₋ₙ)₂O₃; A and B are independently any one selected from the group consisting of Sm, Eu, Gd, Dy, Ho, Er, Tm, Yb, and Lu; x, y, and n satisfy x=6 wt. % to 10 wt. %, y=30 wt. % to 42 wt. %, and 0<n≤1; and x and y represent mass percentages of the Y₂O₃ and the (AₙB₁₋ₙ)₂O₃ in a total mass of the TBC material, respectively.

Preferably, x, y, and n satisfy x=7.5 wt. % to 9 wt. %, y=30 wt. % to 42 wt. %, and n=0.5-1.0.

The present disclosure further provides a preparation method of the TBC material, including the following steps:
subjecting metal oxide raw materials corresponding to the TBC material to first calcination separately to obtain corresponding metal oxide powders; and
mixing the corresponding metal oxide powders to allow ball milling, and then conducting second calcination to obtain the TBC material.

Preferably, the first calcination is conducted at 600° C. to 1,000° C. for no less than 1 h; and the second calcination is conducted at 1,450° C. to 1,600° C. for no less than 6 h.

The present disclosure further provides a preparation method of the TBC material, including the following steps:
mixing a metal source mixed solution corresponding to the TBC material with a precipitant to allow co-precipitation at a pH value of no less than 12 to obtain a precursor precipitate; and
subjecting the precursor precipitate to calcination to obtain the TBC material.

Preferably, the calcination is conducted at 1,300° C. to 1,500° C. for 24 h to 36 h.

The present disclosure further provides a preparation method of the TBC material, including the following steps:
mixing metal oxides corresponding to the TBC material to allow melting to obtain a ceramic melt; and
subjecting the ceramic melt to solidification and crushing to obtain the TBC material.

The present disclosure further provides use of the TBC material of the above technical solution or a TBC material prepared by the preparation method of the above technical solution in a high-temperature hot-end component of an aerospace engine or a gas turbine; where the high-temperature hot-end component has an operating temperature of 1,300° C. to 1,600° C.; and an operating environment of the high-temperature hot-end component includes a CMAS load.

The present disclosure further provides a TBC, including a nickel-based superalloy substrate, a metal adhesive layer, and a surface thermal barrier ceramic (TBC) layer that are stacked in sequence, or including the nickel-based superalloy substrate, the metal adhesive layer, a YSZ layer, and the surface TBC layer that are stacked in sequence; where a material for the surface TBC layer is the TBC material of the above technical solution or a TBC material prepared by the preparation method of the above technical solution.

Preferably, the surface TBC layer is prepared by atmospheric plasma spraying.

The present disclosure provides a TBC material, which targets the cubic fluorite crystal structure and uses different rare earth oxides to co-dope monoclinic phase ZrO₂ to form a fluorite structure. By controlling the doping amount of rare earth oxides to control the crystal defect concentration and lattice distortion, and the doping mass fraction of rare earth oxide is controlled to exceed 20%, the material exhibits a fully-stabilized cubic fluorite crystal structure. Therefore, the material does not undergo phase change at temperatures below the melting point (2,700° C.) and achieves no phase change from a room temperature to 1,600° C. The fluorite-type structure shows high thermal expansion coefficient and fracture toughness. The doping of trivalent rare earth elements with a larger mass fraction replaces the tetravalent Zr⁴⁺ lattice site, forming more point defects and oxygen vacancy defects, which can significantly enhance phonon scattering heat transfer and reduce thermal conductivity, thus exhibiting an advantage of low thermal conductivity. In addition, an increase in crystal defect concentration effectively reduces the diffusion rate between lattice during the sintering, thereby presenting more excellent sintering resistance, making the densification of coatings and ceramics more difficult, such that the TBC material has the advantage of ultra-high-temperature sintering resistance. By controlling the doping amount of rare earth oxides, rare earth ions can effectively promote the growth of refractory phases such as rare earth-apatite, thereby consuming and solidifying to block further penetration of molten CMAS glass and chemical corrosion degradation of the coating substrate. Accordingly, the TBC material has desirable high-temperature/ultra-high-temperature resistance to CMAS corrosion. As a result, the novel TBC has the advantages of high toughness, CMAS corrosion resistance, ultra-high-temperature sintering resistance, and long service life.

In the present disclosure, the TBC material does not undergo phase change at room temperature of about 1,600° C., and the corresponding plasma spray coating has a sintering diffusivity change rate of no more than 25% for 100 h at 1,100° C. to 1,500° C. The coating with a typical microstructure in the sprayed state has a thermal conductivity of no more than 1.21 W/m·K, a fracture toughness of the sintered ceramic block of no less than 3.0 MPa·m¹², and a fracture toughness significantly improved compared to that of pyrochlore-structured rare earth zirconates (approximately 1 MPa m¹²).

The present disclosure provides a TBC. An entire TBC system has an isothermal thermal cycle life (1 h of cycle) of no less than 2,000 times at 1,100° C. In a gas flame thermal gradient cycle test, the thermal cycle life is no less than 18,000 times.

The present disclosure provides a preparation method of the TBC material. In the present disclosure, solid phase reaction, co-precipitation, or melt crushing synthesis is adopted, and the TBC is formed by plasma spraying. The TBC can be used for high-temperature hot-end components of aerospace engines or gas turbines, with operating temperatures up to 1,300° C. to 1,600° C. The TBC material has excellent CMAS corrosion resistance and long thermal cycle life.

### BRIEF DESCRIPTION OF THE DRAWINGS

FIG. 1 shows an X-ray diffraction (XRD) pattern of the powder prepared in Example 1;

FIG. 2 shows an interface microstructure of the powder after plasma spheroidization in Application Example 1;

FIG. 3 shows a surface appearance of the agglomerated powder after sintering in Application Example 2; and

FIG. 4 shows a scanning electron microscopy (SEM) image of the cross section of the TBC prepared in Application Example 3.

### DETAILED DESCRIPTION OF THE EMBODIMENTS

The present disclosure provides a TBC material, where the TBC material has a chemical composition of ZrO₂; xY₂O₃; y(AₙB₁₋ₙ)₂O₃; A and B are independently any one selected from the group consisting of Sm, Eu, Gd, Dy, Ho, Er, Tm, Yb, and Lu; x, y, and n satisfy x=6 wt. % to 10 wt. %, y=30 wt. % to 42 wt. %, and 0<n≤1; and x and y represent mass percentages of the Y₂O₃ and the (AₙB₁₋ₙ)₂O₃ in a total mass of the TBC material, respectively.

Preferably, x, y, and n satisfy x=7.5 wt. % to 9 wt. %, y=30 wt. % to 42 wt. %, and n=0.5-1.0.

In the present disclosure, A and B are different rare earth metal elements; when n=1, only one rare earth metal element is doped.

In the present disclosure, Y₂O₃ represented by x and rare earth oxide represented by y in the TBC material are doped into the ZrO₂ crystal lattice in a corresponding mass fraction to form a solid solution.

The present disclosure further provides a preparation method (high-temperature solid-phase synthesis) of the TBC material, including the following steps:
subjecting metal oxide raw materials corresponding to the TBC material to first calcination separately to obtain corresponding metal oxide powders; and
mixing the corresponding metal oxide powders to allow ball milling, and then conducting second calcination to obtain the TBC material.

In the present disclosure, unless otherwise specified, the raw materials or reagents used all are commercially available products well known to those skilled in the art.

In the present disclosure, metal oxide raw materials corresponding to the TBC material are subjected to first calcination separately to obtain corresponding metal oxide powders.

In the present disclosure, the metal oxide raw materials corresponding to the TBC material are preferably 6 wt. % to 9 wt. % of Y₂O₃-stabilized ZrO₂ (YSZ, purity≥99.9%, solid solution powder) (or Y₂O₃ powder (purity≥99.99%), ZrO₂ powder (purity≥99.5%)) and rare earth oxide Re₂O₃ powder (Re═Sm, Eu, Gd, Dy, Ho, Er, Tm, Yb, or Lu, purity≥99.99%).

In the present disclosure, the first calcination is preferably conducted in an air atmosphere; the first calcination is conducted at preferably 600° C. to 1,000° C. for preferably no less than 1 h, more preferably 2 h to 4 h. Adsorbed water vapor and other volatile substances can be removed through the first calcination to ensure accurate stoichiometric ratios when weighing the raw materials.

In the present disclosure, after the first calcination is completed, an obtained product is preferably cooled to 80° C. in the furnace and transferred to a vacuum oven for storage until later use.

In the present disclosure, the corresponding metal oxide powders are mixed to allow ball milling, and then second calcination is conducted to obtain the TBC material.

In the present disclosure, the ball milling is preferably wet ball milling. The ball milling preferably uses zirconia balls as a ball milling medium and water or absolute ethanol as a liquid medium. There is no special limitation on the amount of the liquid medium and ball milling medium, which can be adjusted according to actual needs. There are no special restrictions on the specific parameters of the ball milling. It is enough to adjust according to actual needs to obtain powder particles of the required particle size. In an example of the present disclosure, the ball milling is conducted at 300 r/min to 320 r/min for 48 h.

In the present disclosure, after the mixing and the ball milling are completed, resulting slurries are transferred to an oven to allow drying, and resulting dried material cakes are crushed and passed through a mesh screen of not less than 100 mesh to obtain a mixed powder. In the present disclosure, the drying is conducted at preferably 130° C. for preferably 48 h to 72 h; the crushing is preferably conducted by mechanical grinding; there is no special limitation on a specific process of mechanical grinding, which can be conducted according to processes well known in the art.

In the present disclosure, the mixed powder is preferably subjected to second calcination to obtain the TBC material. The second calcination is conducted at preferably 1,450° C. to 1,600° C., more preferably 1,450° C. for preferably no less than 6 h, more preferably 12 h to 24 h; the second calcination is preferably conducted in a high-temperature box-type resistance furnace.

In the present disclosure, an obtained product is preferably cooled to room temperature in a furnace and mechanically crushed to obtain the TBC material; preferably, the TBC material is mechanically crushed until an average particle size is no more than 5 μm, more preferably 1 μm.

The present disclosure further provides a preparation method (co-precipitation) of the TBC material, including the following steps:
mixing a metal source mixed solution corresponding to the TBC material with a precipitant to allow co-precipitation at a pH value of no less than 12 to obtain a precursor precipitate; and
subjecting the precursor precipitate to calcination to obtain the TBC material.

In the present disclosure, a metal source mixed solution corresponding to the TBC material is mixed with a precipitant to allow co-precipitation at a pH value of no less than 12 to obtain a precursor precipitate.

In the present disclosure, a metal source in the metal source mixed solution corresponding to the TBC material preferably includes a rare earth oxide Re₂O₃ powder (Re═Sm, Eu, Gd, Dy, Ho, Er, Tm, Yb, or Lu, Purity≥99.99%), Y₂O₃ (purity of 99.99%), and ZrOCl₂·8H₂O.

In the present disclosure, a preparation process of the metal salt mixed solution corresponding to the TBC material preferably includes: weighing the rare earth oxide Re₂O₃ powder and the Y₂O₃ (purity of 99.99%) according to a chemical composition ratio and dissolving same in fuming nitric acid separately, then adding deionized water to prepare a nitrate solution separately, stirring a resulting mixed nitrate solution for 60 min, weighing the corresponding mass of ZrOCl₂·8H₂O powder according to a stoichiometric ratio and adding same into the mixed nitrate solution, and stirring evenly to obtain the metal source mixed solution corresponding to the TBC material. There is no special limitation to a stirring rate, as long as the raw materials are mixed evenly according to procedures well known in the art.

In the present disclosure, the precipitant is preferably ammonia water with a mass concentration of 10%.

In the present disclosure, a process of mixing the metal source mixed solution corresponding to the TBC material and the precipitant preferably includes: adding the precipitant into the metal source mixed solution corresponding to the TBC material under stirring until a resulting solution has a pH value of no less than 12 and no new precipitate appears.

In the present disclosure, the obtained product is preferably continued to be stirred for no less than 60 min, more preferably 120 min, and aged for 60 min; an obtained product is centrifuged, filtered, dried, ground, and crushed in sequence, and passed through a 100-mesh sieve to obtain the precursor precipitate. In the present disclosure, the drying is conducted at preferably 120° C.; there are no special limitation on specific processes of centrifugation, filtration, and grinding and crushing, which can be conducted according to processes well known in the art.

In the present disclosure, the precursor precipitate is subjected to calcination to obtain the TBC material.

In the present disclosure, the calcination is conducted preferably at 1,300° C. to 1,500° C. for preferably 24 h to 36 h in total; the calcination includes preferably first calcination and second calcination in sequence, the first calcination and the second calcination are independently conducted at preferably 1,300° C. to 1,500° C., the first calcination is conducted for preferably 24 h, and the second calcination is conducted for preferably 12 h; and after the first calcination is completed, a resulting material is crushed and passed through a 100-mesh sieve to allow the second calcination.

In the present disclosure, after the calcination is completed, a resulting calcined material is preferably cooled to a room temperature in a furnace, and then ground and crushed to 60 nm to 2 μm to obtain the TBC material. There is no special limitation on the grinding and crushing process, as long as the material with the above particle size requirements can be obtained. The calcination is preferably conducted in a high-temperature box-type resistance furnace.

The present disclosure further provides a preparation method (melt crushing synthesis) of the TBC material, including the following steps:
mixing metal oxides corresponding to the TBC material to allow melting to obtain a ceramic melt; and
subjecting the ceramic melt to solidification and crushing to obtain the TBC material.

In the present disclosure, metal oxides corresponding to the TBC material are mixed to allow melting to obtain a ceramic melt.

In the present disclosure, the metal oxides corresponding to the TBC material preferably include a rare earth oxide Re₂O₃ powder (Re═Sm, Eu, Gd, Dy, Ho, Er, Tm, Yb, or Lu, Purity≥99.99%), Y₂O₃ (purity of 99.99%), and ZrO₂ (purity of 99.99%).

In the present disclosure, the melting is preferably conducted in a high-temperature electric arc furnace; the melting is conducted at 2,760° C. for preferably 120 min.

In the present disclosure, the ceramic melt is subjected to solidification and crushing to obtain the TBC material.

In the present disclosure, the ceramic melt is preferably tilted such that rare earth ions are doped into the ZrO₂ crystal lattice to form a single-phase ceramic liquid solid solution, and high-pressure air is used for impact crushing until the particle size is 1 mm to 3 mm; the high-pressure air is introduced at preferably 12 kg/cm².

The present disclosure further provides use of the TBC material of the above technical solution or a TBC material prepared by the preparation method of the above technical solution in a high-temperature hot-end component of an aerospace engine or a gas turbine; where the high-temperature hot-end component has an operating temperature of 1,300° C. to 1,600° C.; and an operating environment of the high-temperature hot-end component includes a CMAS load.

The present disclosure further provides a TBC, including a nickel-based superalloy substrate, a metal adhesive layer, and a surface TBC layer that are stacked in sequence; where a material for the surface TBC layer is the TBC material of the above technical solution or a TBC material prepared by the preparation method of the above technical solution.

In the present disclosure, the nickel-based superalloy substrate is preferably a cast superalloy, a directionally solidified superalloy, or a single crystal superalloy; there are no special limitation on specific grade and size of the nickel-based superalloy, and any commercially available grade well known in the art can be used; in an example herein, it is specifically a directionally solidified nickel-based superalloy DZ125, a directionally solidified superalloy MAR 247, a GH3128/3230 superalloy, or a nickel-based single crystal superalloy DD10, all of which are Φ30 mm×3 mm discs.

In the present disclosure, the nickel-based superalloy substrate is preferably subjected to pre-treatment before use; the pre-treatment preferably includes: subjecting the nickel-based superalloy substrate to sandblasting on one surface of the disc with 80-mesh corundum under 0.4 MPa compressed air until a surface roughness is Ra=5 μm, ultrasonically cleaning with acetone, and drying in a 100° C. oven.

In the present disclosure, a component of the metal adhesive layer is preferably selected from the group consisting of NiCoCrAlY, NiCrAlY, NiCoCrAlYHfTa, and NiCoCrAlYHfSi; and the metal adhesive layer has a thickness of preferably 100 μm to 200 μm, more preferably 150 μm. There are no special limitations on specific components and content of the metal adhesive layer herein, and any commercially available product well known in the art can be used.

In the present disclosure, the metal adhesive layer is preferably prepared on an alloy substrate by high-velocity oxygen fuel/high-velocity air fuel (HVOF/HVAF) or low-pressure plasma spraying (LPPS); there are no special restrictions on the specific preparation process and parameters of the metal adhesive layer, which can be conducted according to processes well known in the art.

In the present disclosure, a YSZ layer is preferably provided between the metal adhesive layer and the surface TBC layer; the YSZ layer is preferably yttria (Y₂O₃, mole fraction of 3% to 5%)-partially stabilized zirconia (YSZ); the YSZ layer has a thickness of preferably 200 μm to 400 μm and a porosity of preferably 10% to 15%.

In the present disclosure, the YSZ layer is preferably prepared on a surface of the metal adhesive layer by atmospheric plasma spraying; there are no special limitation on specific process and parameters of the atmospheric plasma spraying, which can be conducted in accordance with processes well known in the art.

In the present disclosure, a material for the surface TBC layer is the TBC material of the above technical solution or a TBC material prepared by the preparation method of the above technical solution; the surface TBC layer is preferably prepared on the surface of the YSZ layer by atmospheric plasma spraying; there are no special limitation on specific process and parameters of the atmospheric plasma spraying, which can be conducted in accordance with processes well known in the art. Alternatively, the surface TBC layer is prepared by electron beam-physical vapor deposition (EB-PVD) and has a feather-shaped columnar crystal structure.

In the present disclosure, when the particle size of the TBC material is less than 5 μm, the TBC material is preferably agglomerated into a powder with a particle size of 20 μm to 150 μm using spraying granulation, and is directly used for atmospheric plasma spraying to prepare the TBC; alternatively, the agglomerated powder is preferably further sintered (at 1,100° C. to 1,600° C. for no less than 1 h) or subjected to surface melting plasma spheroidization, and then used to prepare the TBC by atmospheric plasma spraying. There is no special limitation on a process of surface melting plasma spheroidization, which can be conducted according to processes well known in the art. In a use example, the sintering is conducted at 1,050° C. for 24 h.

In the present disclosure, the surface TBC layer has a thickness of preferably 400 μm to 1,800 μm, more preferably 600 μm to 1,500 μm.

In the present disclosure, the surface TBC layer has a structure that is preferably a classic layered porous structure, and its coating porosity is preferably 10% to 30%, more preferably 12 to 15%. Alternatively, the surface TBC layer has a dense vertically cracked (DVC) structure, and its DVC density is preferably 2 lines/mm to 13 lines/mm (the number of DVCs within a width range of 1 mm parallel to an interface direction between the coating and the substrate), more preferably 3.6 lines/mm, and the coating porosity is preferably 8% to 20%, more preferably 12% to 15%. The surface TBC layer has a sprayed thermal conductivity of preferably no more than 1.21 W·m⁻¹K⁻¹.

In the present disclosure, the DVC structure refers to a cross-section of the coating that is perpendicular to the interface between the coating and the metal substrate in the general direction, with a length of greater than ½ of a total thickness of the coating.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the examples of the present disclosure without creative efforts shall fall within the protection scope of the present disclosure.

### Example 1

A thermal barrier ceramic material powder ZrO₂; 6.0 wt. % Y₂O₃; 42 wt. % Sm₂O₃ was prepared using high-temperature solid-phase synthesis:

Three powders of ZrO₂ (purity of 99.9%), Sm₂O₃ (purity of 99.99%), and Y₂O₃ (purity of 99.99%) were calcined at 1,000° C. for 4 h; the three powders were weighed according to a stoichiometric ratio and put into a ball milling tank. The zirconia milling balls were added to the ball milling tank. After adding deionized water, ball milling was conducted for 48 h at 320 r/min; after the ball milling was completed, the slurry in the ball milling tank was completely transferred to a stainless steel container, dried in an oven at 130° C. for 48 h, and then a dried material cake was mechanically ground and crushed through a 100-mesh sieve; a sieved mixed powder was placed in a high-temperature box-type resistance furnace at 1,450° C. for 12 h, then cooled to room temperature in the furnace, and mechanically crushed to an average particle size of ≤5 μm.

### Example 2

A thermal barrier ceramic material powder ZrO₂; 10.0 wt. % Y₂O₃; 42 wt. % (Sm_{0.5}Gd_{0.5})₂O₃ was prepared by co-precipitation:

Sm₂O₃ (purity of 99.99%), Gd₂O₃ (purity of 99.99%), and Y₂O₃ (purity of 99.99%) were weighed and dissolved in fuming nitric acid separately according to a stoichiometric ratio. The deionized water was added to prepare three kinds of nitrate solutions with a concentration of 1 mol/L; the above three nitrate solutions were mixed by stirring for 60 min, the ZrOCl₂·8H₂O powder was weighed according to the stoichiometric ratio and added to the resulting mixed solution, and stirred evenly; while stirring continuously, ammonia water with a concentration of 10 wt. % was added to the resulting mixed solution dropwise until the pH of the solution was 12 and no new precipitate appeared. The mixed solution was stirred for 120 min and then aged for 60 min. The precipitated mixture was centrifuged, filtered, and dried in an oven at 120° C.; the dry cake was ground and passed through a 100-mesh sieve. A sieved mixed powder was placed in a high-temperature box-type resistance furnace to allow heat preservation at 1,300° C. for 24 h, taken out and crushed through a 100-mesh sieve, followed by heat preservation at 1,450° C. for 12 h, and then cooled to room temperature in the furnace, ground and crushed until the particle size was 60 nm to 2 μm.

### Example 3

A thermal barrier ceramic material powder ZrO₂; 7.5 wt. % Y₂O₃; 30 wt. % (Eu_{0.5}Yb_{0.5})₂O₃ was prepared by arc melting and crushing:

Eu₂O₃ (purity of 99.99%), Y₂O₃ (purity of 99.99%), Yb₂O₃ (purity of 99.99%), and ZrO₂ (purity of 99.9%) were weighed according to a chemical composition ratio, added together to an arc melting furnace, and smelted at 2,760° C. for 120 min. Then the ceramic liquid solid solution was tilted and then impacted with 12 kg/cm² high-pressure air and crushed to 1 mm to 3 mm.

### Example 4

A thermal barrier ceramic material powder ZrO₂; 7.5 wt. % Y₂O₃; 30 wt. % (Gd_{0.7}Yb_{0.3})₂O₃ was prepared using high-temperature solid-phase synthesis:

Four powders of ZrO₂ (purity of 99.9%), Y₂O₃ (purity of 99.99%), Gd₂O₃ (purity of 99.99%), and Yb₂O₃ (purity of 99.99%) were calcined at 600° C. for 2 h; the four powders were weighed according to a stoichiometric ratio and put into a ball milling tank. The zirconia milling balls were added to the ball milling tank. After adding deionized water, ball milling was conducted for 48 h at 300 r/min; after the ball milling was completed, the slurry in the ball milling tank was completely transferred to a stainless steel container, dried in an oven at 130° C. for 72 h, and then a dried material cake was mechanically ground and crushed through a 100-mesh sieve; a sieved mixed powder was placed in a high-temperature box-type resistance furnace at 1,600° C. for 24 h, then cooled to room temperature in the furnace, and mechanically crushed to an average particle size of 1 μm.

### Application Example 1

The ZrO₂; 6.0 wt. % Y₂O₃; 42 wt. % Sm₂O₃ powder prepared in Example 1 was subjected to spraying granulation, screened for powders in a particle size of 20 μm to 100 μm, and subjected to plasma spheroidization to obtain a powder for plasma spraying.

A directionally solidified nickel-based superalloy DZ125 was used as a substrate (a disc with a size of φ30 mm×3 mm), one surface of the disc was sandblasted with 80-mesh corundum under 0.4 MPa compressed air until a surface roughness was Ra=5 μm, and then ultrasonically cleaned with acetone and dried in a 120° C. oven.

A NiCrAlYHfTa metal adhesive layer was prepared on a surface of the circular DZ125 superalloy specimen using HVOF, with a thickness of 100 μm.

A thermal barrier ceramic layer of YSZ (Meike 204NS series powder) with a thickness of 200 μm was prepared on the metal adhesive layer by atmospheric plasma spraying, with a porosity of 10%.

A thermal barrier ceramic layer with a thickness of 1,800 μm was prepared on a surface of the YSZ layer by atmospheric plasma spraying. The thermal barrier ceramic layer had a DVC structure with a DVC density of 2.0 lines/mm and a total coating porosity of 12%, and a double ceramic layer high-temperature TBC was obtained.

### Application Example 2

The thermal barrier ceramic material powder prepared in Example 2 was processed by spray granulation to obtain hollow spherical agglomerated particles with a particle size of 20 μm to 120 μm. After sintering at 1,050° C. for 24 h, the agglomerated powder was used for plasma spraying coating to prepare TBC.

A single-crystal superalloy DD10 was used as a substrate (a disc with a size of φ30 mm×3 mm), one surface of the disc was sandblasted with 80-mesh corundum under 0.4 MPa compressed air until a surface roughness was Ra=5 μm, and then ultrasonically cleaned with acetone and dried in a 100° C. oven.

A NiCoCrAlYHfSi metal adhesive layer was prepared on a surface of the single-crystal superalloy circular disc using LPPS, with a thickness of 150 μm.

A thermal barrier ceramic layer of YSZ (Meike 204NS series powder) with a thickness of 400 μm was prepared on the metal adhesive layer by atmospheric plasma spraying, with a porosity of 15%.

A thermal barrier ceramic layer with a thickness of 600 μm was prepared on a surface of the YSZ layer by atmospheric plasma spraying. The thermal barrier ceramic layer had a classic layered porous structure with a porosity of 30% and a thermal conductivity of 0.55 W·m⁻¹·K⁻¹ in the sprayed state, resulting in a double ceramic layer high-temperature TBC.

### Application Example 3

The thermal barrier ceramic layer material powder prepared in Example 3 was mechanically crushed to further collect the resulting powder of 5 μm to 60 μm, which was directly used for atmospheric plasma spraying to prepare TBC.

A GH3128/3230 superalloy was used as a substrate (a disc with a size of φ30 mm×3 mm), one surface of the disc was sandblasted with 60-mesh corundum under 0.4 MPa compressed air until a surface roughness was Ra=5 μm, and then ultrasonically cleaned with acetone and dried in a 100° C. oven.

A NiCrAlY metal adhesive layer was prepared on a surface of the single-crystal superalloy circular disc using LPPS, with a thickness of 200 μm.

A thermal barrier ceramic layer with a thickness of 1,500 μm was prepared on a surface of the metal adhesive layer by atmospheric plasma spraying. The thermal barrier ceramic layer had a DVC structure with a DVC density of 3.6 lines/mm and a total layer porosity of 12%, and a single layer DVC-structured TBC was obtained.

### Application Example 4

The thermal barrier ceramic material powder prepared in Example 4 was subjected to spraying granulation into a high-fluidity agglomerated powder, and a powder with a particle size of 20 μm to 100 μm was sieved and used for atmospheric plasma spraying to prepare TBC.

A directionally solidified superalloy MAR 247 was used as a substrate (a disc with a size of φ30 mm×3 mm), one surface of the disc was sandblasted with 60-mesh corundum under 0.4 MPa compressed air until a surface roughness was Ra=5 μm, and then ultrasonically cleaned with acetone and dried in a 100° C. oven.

A NiCoCrAlY metal adhesive layer was prepared on a surface of the single-crystal superalloy circular disc using LPPS, with a thickness of 100 μm.

A thermal barrier ceramic layer of YSZ (Meike 204NS series powder) with a thickness of 200 μm was prepared on the metal adhesive layer by atmospheric plasma spraying, with a porosity of 10%.

A thermal barrier ceramic layer with a thickness of 400 μm was prepared on a surface of the metal adhesive layer by atmospheric plasma spraying. The thermal barrier ceramic layer had a DVC structure with a DVC density of 13 lines/mm and a total layer porosity of 15%, and a double layer DVC-structured TBC was obtained.

### Characterization and Performance Test

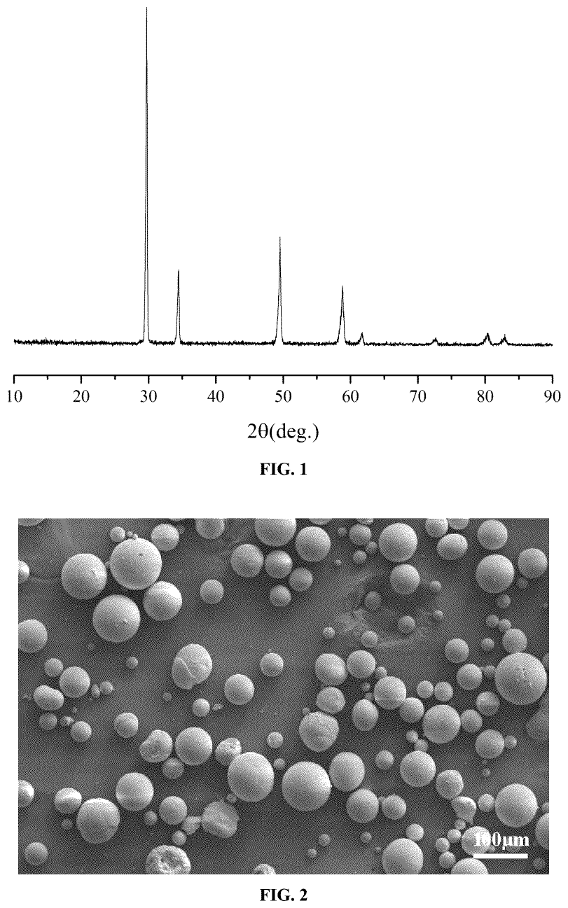

1) FIG. 1 showed an XRD pattern of the thermal barrier ceramic coating material powder prepared in Example 1. As shown in FIG. 1, the prepared powder was in a single fluorite solid solution phase, had no second phase diffraction peak, and showed high chemical purity.

2) FIG. 2 showed an interface microstructure of the powder after plasma spheroidization in Application Example 1. As shown in FIG. 2, the interior of the plasma spheroidized powder had varying degrees of hollow structures, but the surface of the powder particles was continuously dense; the surface of the powder after plasma spheroidization was relatively smooth and flat, showing a typical characteristic of plasma melting spheroidization.

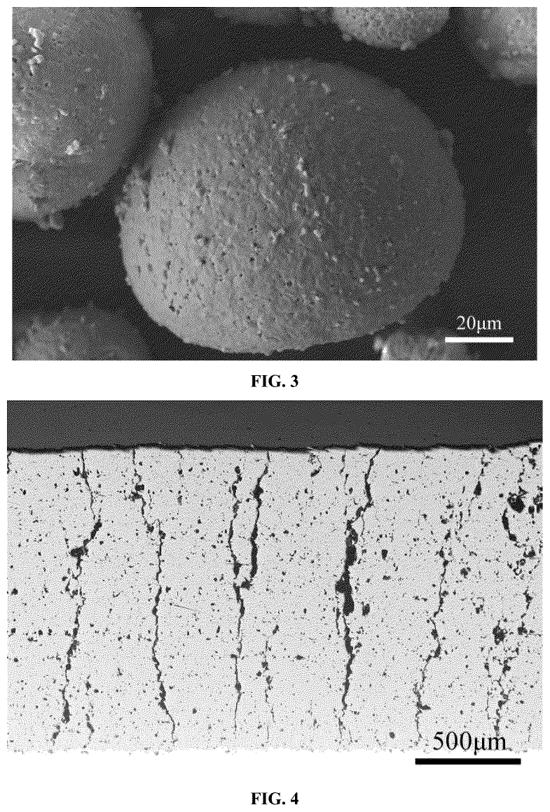

3) FIG. 3 showed a surface appearance of the agglomerated powder after sintering in Application Example 2. As shown in FIG. 3, the grain boundaries of the sintered diffusion ceramic grains and some pores were observed on the surface of powder particles. The morphology of this type of powder particles also had an important impact on the porosity control and vertical crack growth of the APS coating.

4) FIG. 4 showed a SEM image of the cross section of the TBC prepared in Application Example 3. The TBC was a single-layer DVC structure with a DVC density of 3.6 lines/mm and a coating porosity of 12%.

5) The laser thermal conductivity testing was conducted on the TBCs prepared in Application Examples 1 to 4. The results showed that the average thermal conductivities of the TBCs prepared in Appication Examples 1 to 4 were: 1.18 W·m⁻¹·K⁻¹, 0.55 W·m⁻¹·K⁻¹, 0.68 W·m⁻¹·K⁻¹, and 1.21 W·m⁻¹·K⁻¹; the sintering diffusivity change rates of the sprayed coating from 1,100° C. to 1,500° C. for 100 h were: 25%, 15%, 18%, and 15%, respectively, indicating excellent high temperature sintering resistance.

6) The TBCs prepared in Application Examples 1 to 4 were tested for fracture toughness using the unilateral notch method. The fracture toughness were: 3.6 MPa-m^{1/2}, 3.2 MPa-m^{1/2}, 3.0 MPa·m^{1/2}, and 3.6 MPa·m^{1/2}, respectively.

7) The TBCs prepared in Application Examples 1 to 4 were tested with a thenmogravimetric-differential scanning calorimeter (NETZSCH, TG-DSC). The results showed that there was no phase change at room temperature to 1,600° C.

8) NETZSCH high-temperature thermal expansion tester was used to detect a thermal expansion coefficient. The thermal expansion coefficients of the TBCs prepared in Application Examples 1 to 4 were 11.6×10⁻⁶ K⁻¹, 12.0×10⁻⁶ K⁻¹, 12.0×10⁻⁶ K⁻¹, and 11.0×10⁻⁶ K⁻¹, respectively.

9) The anti-CMAS penetration performance was tested: 30 mg/cm² CMAS mixed powder was placed on the surface of the TBC sample (ie, surface load of 30 mg/cm²), subjected to heat preservation in an air atmosphere at 1,500° C. for 100 h, and the coating was cut to observe sample interface. A CMAS penetration depth was determined through SEM photo cross-sections and energy spectrum images. The results showed that the TBCs prepared in Application Examples 1 to 4 could block the penetration of high-temperature CMAS. The TBC in Application Example 1 had a CMAS corrosion layer thickness of ≤80 μm at 1,500° C. and 100 h; the TBC in Application Example 2 had a CMAS corrosion layer thickness of ≤60 μm at 1,500° C. and 100 h; the TBC in Application Example 3 had a CMAS corrosion layer thickness of ≤65 μm at 1,500° C. and 100 h; the TBC in Application Example 4 had a CMAS corrosion layer thickness of ≤60 μm at 1,500° C. and 100 h.

10) A gas flame thermal gradient cycle test was conducted on the TBCs prepared in Application Examples 1 to 4. The coating surface test temperature was at 1,300° C. to 1,600° C., and the coating surface was heated by flame for 5 min, then the flame was removed and cooled for 2 min. The results showed that the TBC prepared in Application Example 1 had a gas flame thermal shock cycle life of up to 26,000 times at a surface test temperature of 1,580° C. The TBC prepared in Application Example 2 had a gas flame thermal shock cycle life of up to 25,000 times at a surface test temperature of 1,600° C. The TBC prepared in Application Example 3 had a gas flame thermal shock cycle life of up to 23,000 times at a surface test temperature of ≤1,600° C. The TBC prepared in Application Example 4 had a gas flame thermal shock cycle life of up to 32,000 times at a surface test temperature of ≤1,600° C.

11) The entire coating samples prepared in Application Examples 1 to 4 were placed in an electric furnace at 1,100° C. for 1 h, then taken out and cooled in the air for 10 min, the above process was recorded as one thermal cycle. This cycle repeated until the ceramic layer stopped peeling off from the surface of the substrate, and an accumulated number of times was the thermal cycle life. The results showed that:

The isothermal thermal cycle life (1 h cycle) of the TBC prepared in Application Example 1 at 1,100° C. was 2,300 times. The isothermal thermal cycle life (1 h cycle) of the TBC prepared in Application Example 2 at 1,100° C. was 2,200 times. The isothermal thermal cycle life (1 h cycle) of the TBC prepared in Application Example 3 at 1,100° C. was 2,000 times. The isothermal thermal cycle life (1 h cycle) of the TBC prepared in Application Example 4 at 1,100° C. was 3,000 times.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

1. A thermal barrier coating (TBC), comprising a nickel-based superalloy substrate, a metal adhesive layer, and a surface thermal barrier ceramic (TBC) layer that are stacked in sequence, or comprising the nickel-based superalloy substrate, the metal adhesive layer, a yttria-stabilized zirconia (YSZ) layer, and the surface TBC layer that are stacked in sequence; wherein
the nickel-based superalloy substrate is selected from the group consisting of a cast superalloy, a directionally solidified superalloy, and a single crystal superalloy;
a component of the metal adhesive layer is selected from the group consisting of NiCoCrAlY, NiCrAlY, NiCoCrAlYHfTa, and NiCoCrAlYHfSi; and the metal adhesive layer has a thickness of 100 μm to 200 μm;
the YSZ layer is yttria-partially stabilized zirconia with yttria in a molar faction of 3% to 5%; and the YSZ layer has a thickness of 200 μm to 400 μm and a porosity of 10% to 15%;
the surface TBC layer has a thickness of 400 μm to 1,800 μm; a material for the surface TBC layer is a TBC material with a chemical composition of ZrO₂; xY₂O₃; y(AₙB₁₋ₙ)₂O₃; A and B are independently any one selected from the group consisting of Sm, Eu, Gd, Dy and Yb; x, y, and n satisfy x=7.5 wt. % to 9 wt. %, y=30 wt. % to 42 wt. %, and n=0.5 to 1.0; and x and y represent mass percentages of the Y₂O₃ and the (AₙB₁₋ₙ)₂O₃ in a total mass of the TBC material, respectively.

2. (canceled)

3. The TBC according to claim 1, wherein a preparation method of the TBC comprises the following steps:
subjecting metal oxide raw materials corresponding to the TBC material to first calcination separately to obtain corresponding metal oxide powders; and
mixing the corresponding metal oxide powders to allow ball milling, and then conducting second calcination to obtain the TBC material.

4. (canceled)

5. The TBC according to claim 3, wherein the first calcination is conducted at 600° C. to 1,000° C. for no less than 1 h; and the second calcination is conducted at 1,450° C. to 1,600° C. for no less than 6 h.

6. The TBC according to claim 1, wherein a preparation method of the TBC comprises the following steps:
mixing a metal source mixed solution corresponding to the TBC material with a precipitant to allow co-precipitation at a pH value of no less than 12 to obtain a precursor precipitate; and
subjecting the precursor precipitate to calcination to obtain the TBC.

7. (canceled)

8. The TBC according to claim 6, wherein the calcination is conducted at 1,300° C. to 1,500° C. for 24 h to 36 h.

9. (canceled)

10. (canceled)

11. The TBC according to claim 1, wherein a preparation method of the TBC material comprises the following steps:
mixing metal oxides corresponding to the TBC material to allow melting to obtain a ceramic melt; and
subjecting the ceramic melt to solidification and crushing to obtain the TBC.

12. (canceled)

13. (canceled)

14. (canceled)

15. The TBC according to claim 1, wherein the surface TBC layer is prepared by atmospheric plasma spraying.

16. (canceled)
